(19) United States
(12) Patent Application Publication
(10) Pub. No.: US 2017/0059527 A1
(43) Pub. Date: Mar. 2, 2017

(54) Hand-Held Eddy Current Test Instrument and Sensor

(71) Applicant: CoreStar International Corporation, Irwin, PA (US)

(72) Inventor: Edward Lopez, Ruffs Dale, PA (US)

(21) Appl. No.: 15/250,963

(22) Filed: Aug. 30, 2016

Related U.S. Application Data
(60) Provisional application No. 62/212,838, filed on Sep. 1, 2015.

(51) Int. Cl. G01N 27/90

(52) U.S. Cl. CPC G01N 27/9006

(57) ABSTRACT

In a method of eddy current testing via an eddy current testing instrument, in response to the eddy current test instrument experiencing acceleration, the eddy current test instrument outputs an alternating magnetic field which induces eddy currents in a specimen and detects the induced eddy currents. When the eddy current test instrument is not experiencing acceleration, after a delay, the eddy current test instrument withholds outputting the alternating magnetic field to, thereby, conserve power.

### CROSS REFERENCE TO RELATED APPLICATION

This application claims the benefit of U.S. Provisional Patent Application No. 62/212,838, filed Sep. 1, 2015, which is incorporated herein by reference in its entirety.

### BACKGROUND OF THE INVENTION

Field of the Invention

The present invention relates to Eddy Current Testing.

Description of Related Art

Eddy Current Test Instruments are used in the inspection of conductive material. Typical uses include inspecting heat exchanger tubing ID, tubing OD, pipe welds, aircraft frame and fuselage, wheel rims, axles, train rails, wire rope, and many other places where the integrity of a conductive material must be inspected.

One segment of the eddy current test instrument market is the handheld, battery powered test instrument. Handheld instruments are typically used for surface inspections where the inspector has to move frequently while inspecting the part. This type of inspection can only be performed by a lightweight and battery powered instrument.

All existing handheld eddy current test instruments require the instrument to either be placed on a flat surface or physically held by the inspector in one hand while the sensor, which is connected to the instrument by a flexible cable, is moved along the part being inspected.

Different sensors designed for different applications can be connected to the test instrument.

### SUMMARY OF THE INVENTION

Disclosed herein is an eddy current test instrument and an eddy current sensor packaged in the same body.

Since the sensor and the test instrument are contained in the same body, they can be moved along the defect in just the same way that the sensor alone is moved in other eddy current instruments, but without external wires. Hence, the inspector does not have to worry about wire length limitations and other limitation on their movement while performing eddy current inspection.

In addition, the test instrument includes an accelerometer based power savings mode. This would not be possible unless the test instrument and the sensor were part of the same rigid body. The test instrument goes into sleep mode after a configurable period of inactivity and immediately resumes full power mode when it is moved. In existing test instruments, the test instrument does not move along with the sensor so this method of implementing a low power mode is not possible.

The test instrument can include replaceable sensors. These replaceable sensors allow for the flexibility to perform a wide variety of inspections on different types of specimens made from the same or different materials. The sensor (e.g., tips) can interface with the test instrument in the same way, but have different lengths and shapes and are designed for different test applications. The replaceable tips are removably attached rigidly to the same housing that houses the test instrument electronics.

The test instrument can be configured by a remote external computing device. The test instrument communicates with this device wirelessly. When active, the test instrument streams eddy current data back to the device for display, analysis, and/or optional data storage.

### BRIEF DESCRIPTION OF THE DRAWINGS

FIG. 1 is a block diagram electrical schematic of the electrical elements of the example eddy current test instrument described herein;

FIG. 2 is a perspective view of the assembled eddy current test instrument;

FIG. 3 is an exploded perspective view of the eddy current test instrument of FIG. 2; and

FIG. 4 is an exploded perspective view of a wiring assembly shown in the perspective view of FIG. 3.

### DESCRIPTION OF THE INVENTION

The present invention will now be described with reference to the accompanying figures where like reference numbers correspond to like or functionally equivalent elements.

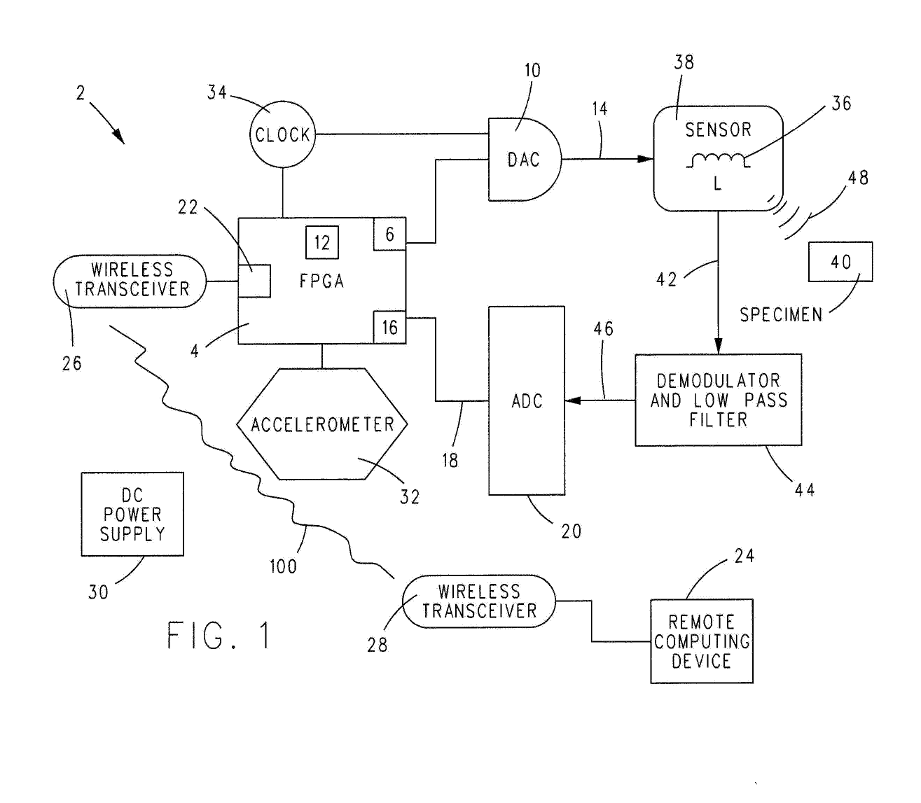

With reference to FIG. 1, a hand-held eddy current test instrument and sensor (hereinafter “instrument 2”) comprises electrical elements or components housed inside of a housing (described hereinafter).

In an example, instrument 2 includes a controller such as, for example, a microprocessor or a field programmable gate array (FPGA) 4. For the purpose of description, it will be assumed that instrument 2 includes FPGA 4. However, this is not to be construed in a limiting sense.

In an example, FPGA 4 is programmed to control all of the logic of instrument 2 in the manner described hereinafter. In an example, FPGA 4 can include an internal numerically controlled oscillator 6 having an output 8 that drives a digital-to-analog converter (DAC) 10. FPGA can also include a binary multiplier 12 that is operative for scaling an output 14 of DAC 10 digitally.

FPGA 4 can also include logic circuitry 16 that is operative for sampling an output of an analog-to-digital converter (ADC) 20. FPGA 4 can further include logic circuitry 22 that is operative for parsing data samples into packets and then sending them wirelessly to a remote computing device 24 for display, analysis, and/or storage. The wireless transmission of packets sent by FPGA 4 to remote computing device 24 can be via a wireless transmitter or transceiver 26 coupled to FPGA 4 and a wireless receiver or transceiver 28 connected to remote computing device 24. For purposes of description, elements 26 and 28 will be described as being wireless transceivers. However, this is not to be construed in a limiting sense since it is envisioned that element 26 can be a wireless transmitter and element 28 can be a wireless receiver. In an example, remote computing device 24 can be a desktop computer, a laptop computer, a smart phone, a tablet computer, and/or any other suitable and/or desirable computing device now known or hereinafter developed.

A DC power supply 30, in an example, a battery, can supply DC electrical power to the components of instrument 2 in a manner known in the art.

Instrument 2 can further include an accelerometer 32 coupled to FPGA 4 which is operative for detecting the output of accelerometer 32 and for modifying the operation of instrument 2 based on the output of accelerometer 32. In an example, FPGA 4 can be configured to implement a low-power mode of operation in response to accelerometer 32 detecting no acceleration of instrument 2, e.g., instrument 2 is stationary, and to implement of test-mode of operation when accelerometer 32 detects acceleration. A clock 34 can be provided as an oscillator for outputting a reference clock signal to inputs of FPGA 4 and DAC 10 for the operation thereof in a manner known in the art, i.e., to control the timing of FPGA 4 an DAC 10 .

In operation, FPGA 4 is configured to drive DAC 10 to produce a sine wave of a given frequency. This output is amplified and is utilized to drive one or more coils 36 of a sensor 38 of instrument 2. The one or more coils 36 are configured to output time varying magnetic fields that interact with a specimen 40 under test. More particularly, FPGA 4 is configured to drive DAC 10 to produce the sine wave of a given frequency which drives the coils 36 of sensor 38 in a manner to produce eddy currents in specimen 40 in a first instance of time and to detect said eddy currents and provide an eddy current signal 42 to a block 44 that includes circuitry for amplifying, demodulating, and/or low pass filtering (as needed) the eddy current signal to a form suitable for presentation via an output of block 44 to an input of ADC 20 in a second, subsequent period of time.

In an example, ADC 20 converts the output 46 of block 44 to digital values which are provided to logic circuitry 16 of FPGA via output 18 of ADC 20. In response, FPGA 4 parses the digital values (also known as data samples) into packets and sends them wirelessly to remote computing device 24 as discussed above.

Accelerometer 32 can detect whether instrument 2 is accelerating (change in motion) or not and output a corresponding signal to FPGA 4 which determines therefrom whether or not to enter or exit a low-power mode of operation.

Finally, wireless data communication between wireless transceivers 26 and 28 can be via bluetooth, WIFI, or any other suitable and/or desirable wireless protocol, now known or hereinafter developed, via a wireless link 100 between wireless transceivers 26, 28.

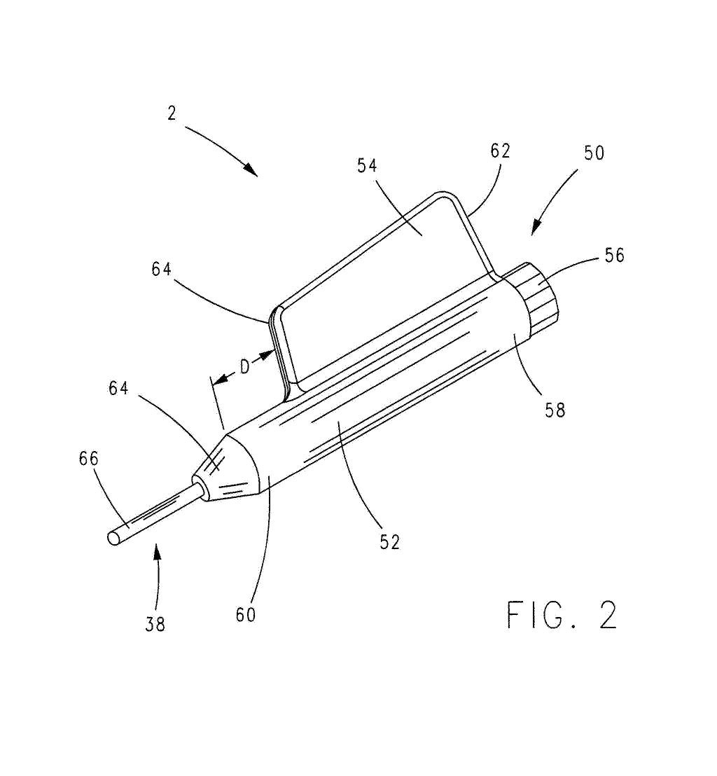

With reference to FIG. 2 and with continuing reference to FIG. 1, in an example, an exterior of instrument 2 can include a housing 50 including a tubular portion 52 and a fin portion 54 extending laterally from an exterior surface of tubular portion 52. In an example, fin portion 54 can extend from adjacent a cap 56 coupled to a back end 58 of tubular portion 52 toward a front end 60 of tubular portion 52. In an example, a back end 62 of fin 54 can be adjacent back end 58 of tubular portion 52 while a front end 64 of fin 54 can be spaced from front end 60 of tubular portion 52 by a distance D. However, this is not to be construed in a limiting sense.

Fin section 54 can be configured to house a PC board (PCB) 68 on which the electronic elements described above in connection with FIG. 1 are mounted, with the exception of remote computing device 24, wireless transceiver 28, sensor 38, coils 36, and specimen 40.

Instrument 2 can further include a replaceable tapered end piece 64 which facilitates inspection of a large variety of specimens 40 of different types. A distal end of end piece 64 is configured to support a replaceable tip 66 that houses coils 36. Replaceable tip 66 is the part of instrument 2 that is dragged or moved over specimen 40 while holding instrument 2 like a pen or pencil.

Cap 56 is operative for being screwed and unscrewed to facilitate replacement of an internal DC power supply 30 in the form of a one-time use or rechargeable battery.

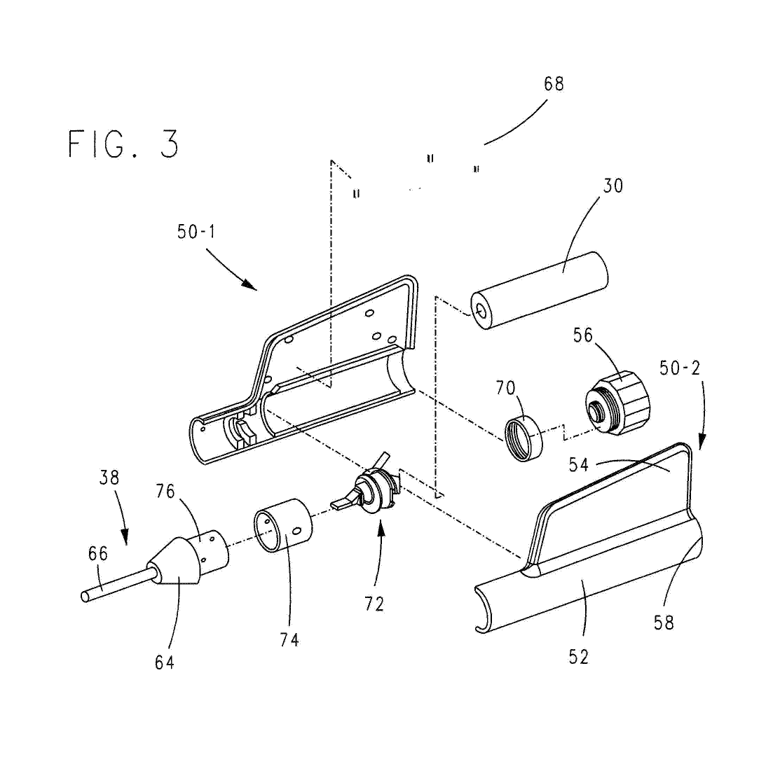

With reference to FIG. 3 and with continuing reference to FIGS. 1 and 2, in an example, housing 50 can be a two-part housing comprised of housing parts 50-1 and 50-2. The fin portion 54 of housing 50 houses PCB 68 which supports at least elements 4, 26, 34, 10, 44, and 20 of instrument 2 shown in FIG. 1.

The tubular portion 52 of housing 50 can be configured to support DC power supply 30 in the form of a battery 30 which can be inserted into tubular portion 52 via opened back end 58 when cap 56 is removed.

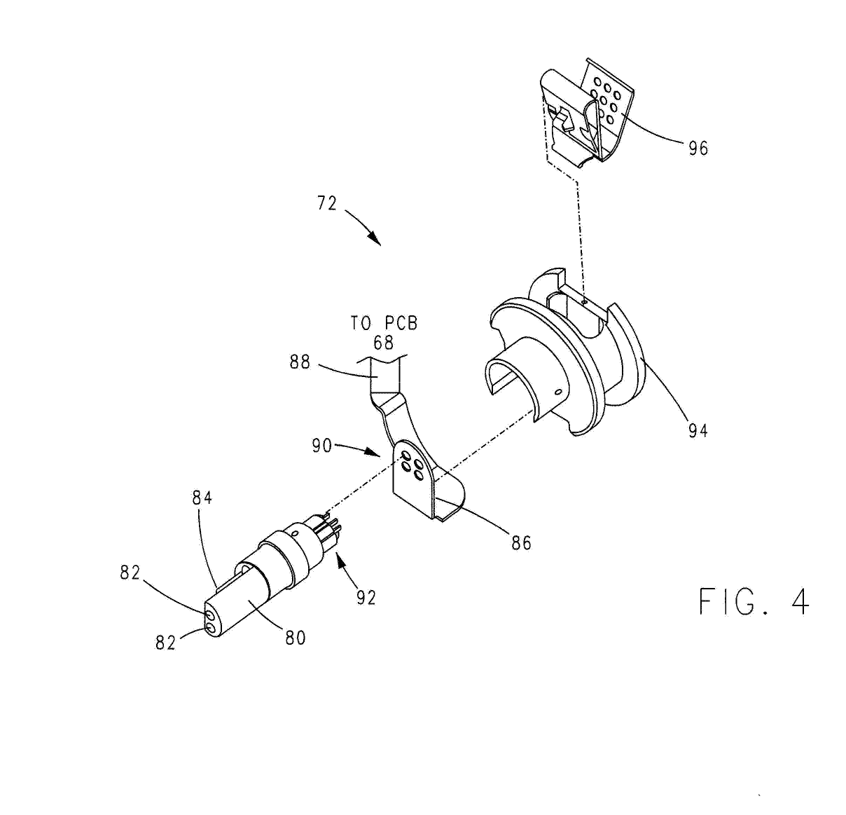

In an example, an interior of housing 50 can support a threaded insert 70 that is affixed in housing 50 adjacent back end 58. Threaded insert 70 is the mating side to cap 56 and makes electrical connection to PCB 68. Housing 50 can also house a wiring assembly 72, discussed in greater detail in connection with FIG. 4.

Adjacent front end 60, housing 50 can house a rigid collar 74 that is configured to receive inserted therein a tubular portion 76 of end piece 64. In an example, collar 74 can be a metal ring that is mechanically affixed within housing 50. In an example, collar 74 protects a sensor tip connector 80 (FIG. 4) and reinforces the proximal end of replaceable tip 66 that plugs into sensor tip connector 80. In an example, collar 74 can be keyed to insure proper alignment of sensor tip connector 80. In an example, a proximal end of replaceable tip 66 can mate with (plug into) sensor tip connector 80. Different replaceable tips 66 can be available for different types of inspections as is known in the art.

With reference to FIG. 4 and with continuing reference to FIGS. 1-3, wiring assembly 72 includes sensor tip connector 80 configured to mate with a proximal end (not shown) of replaceable tip 66. In an example, a distal end of sensor tip connector 80 includes female electrical contacts 82 for mating with electrical pins (not shown) on the proximal end of replaceable tip 66. Sensor tip connector 80 can also include a flat surface 84 configured to engage a mating flat surface (not shown) on the proximal end of replaceable tip 66 to insure proper alignment and engagement of the electrical pins on the proximal end of replaceable tip 66 with the female electrical contacts 82 of sensor tip connector 80.

Wiring assembly 72 can also include a bracket 86 that supports a flexible flat cable 88 that connects to PCB 68. Bracket 86 also includes a connector 90 that acts as an interface between the wires of flexible cable 88 and contacts or electrical connections of a mating connector 92 of sensor tip connector 80.

Wiring assembly 72 can also include a wiring alignment fixture 94 that acts as an interface between an interior of tubular portion 52 of housing 50 and sensor tip connector 80 to aid in supporting sensor tip connector 80 on housing 50 and to avoid rotation of sensor tip connector 80 and, hence, replaceable tip 66 relative to housing 50.

Finally, wiring assembly 72 can include a positive battery contact 96 that couples to wiring alignment fixture 94 and acts to provide positive voltage from DC power supply (battery) 30 to PCB 68.

Having thus described example instrument 2, an example operation of instrument 2 will now be described.

In response to DC power supply (battery) 30 supplying power to FPGA 4, accelerometer 32, wireless transceiver 26, clock 34, DAC 10, block 44, and ADC 20 when instrument 2 is experiencing acceleration, FPGA 4 causes DAC 10 to output to coils 36 a sine wave of a pre-determined frequency. In response to this sine wave, coils 36 output an alternating magnetic field 48 that induces in specimen 40 eddy currents that can be sampled by coils 36. The signals produced in coils 36 in response to sensing eddy currents in specimen 40 can be amplified, demodulated, and/or low pass filtered (as deemed suitable and/or desirable) by block 44 and presented to ADC 20 that converts the output 46 of block 44 into digital equivalent data values over time. In response to these digital equivalent data values received by logic circuitry 16 of FPGA 4 via output 18 of ADC 20, FPGA 4 causes these digital equivalent data values to be forwarded to remote computing device 24 via logic circuitry 22 of FPGA 4, wireless transceivers 26 and 28, and wireless link 100.

Remote computing device 24 can include appropriate software for analyzing the received digital equivalent data values in a manner known in the art to determine if the area of specimen 40 in which eddy currents are induced by coils 36 contains a defect or not.

In an example, FPGA 4 determines via the output of accelerometer 32 whether instrument 2 is experiencing acceleration. For example, in response to accelerometer 32 outputting to FPGA 4 a signal indicative of accelerometer 32 detecting acceleration, FPGA 4 can cause eddy currents in specimen 40 to be induced and sampled in the manner described above.

However, if accelerometer 32 outputs to FPGA 4 is signal indicative of no acceleration of instrument 2, which lack of acceleration is indicative of, for example, the instrument being set down and/or not used, FPGA 4 can enter into a low-power mode of operation where FPGA 4 reduces its power consumption over a test-mode of operation where FPGA 4 is fully operational and capable of inducing and sampling eddy currents in sample 40. The low-power mode can also include FPGA 4 not operating one or more of oscillator 6, logic circuitry 16 and/or 22, DAC 10, ADC 20, one or more or all of the amplifier, demodulator, and/or low pass filter of block 44, and/or wireless transceiver 26.

In the low-power mode of operation, the alternating magnetic field 48 is not output by instrument 2. In this manner, the power of DC power supply (battery) 30 can be conserved and eddy currents are not induced in or acquired from specimen 40.

FPGA 4 can be configured to provide a delay between the time accelerometer 32 outputs a signal indicative of no acceleration and the time when accelerometer 32 outputs a signal to shut down the test instrument. The purpose of this delay is to only shut down the test instrument if it is set down for more than a user selectable amount of time. The length of this delay can be selected by one of ordinary skill in the art in any suitable or desirable manner and programmed into FPGA 4 in a manner known in the art. In an example, this delay can be 120 seconds, 1 second, or any period of time between 120 seconds and 1 second. However, this is not to be construed in a limiting sense since the duration of such delay can be selected in any suitable and/or desirable manner, e.g., to conform to a particular user's style of doing eddy current testing using instrument 2.

In an example, the output of accelerometer 32 can be provided to an interrupt input of FPGA 4. In an example, FPGA 4 can be configured to be responsive to the output of accelerometer 32 presented to this interrupt input to run in a test-mode of operation when accelerometer is detecting acceleration and to operate in the low-power mode of operation when accelerometer 32 is not (after the delay discussed above) detecting acceleration.

The foregoing listing of elements that are not operated by FPGA 4 in the low-power mode of operation is exemplary only and is not to be construed in a limiting sense since it is envisioned that FPGA 4 can terminate control of and, hence, the consumption of power by any one or more combination of elements 26, 10, 44, and 20 as deemed suitable and/or desirable by one of ordinary skill in the art.

In an example, FPGA 4 can be configured to automatically switch between the low-power mode of operation (or a low-power state) when instrument 2 is not accelerating and a test-mode of operation (or a test state), where all of the electrical elements of instrument 2 are used to perform eddy current testing, when FPGA 4 determines via accelerometer 32 that instrument 2 is accelerating.

The examples have been described with reference to the accompanied figures. Modifications and alterations will occur to others upon reading and understanding the foregoing examples. Accordingly, the foregoing examples are not to be construed as limiting the disclosures.

The invention claimed is:

1. A method eddy current testing using an eddy current test instrument including an eddy current sensor comprising:
(a) in response to the eddy current test instrument experiencing acceleration, the eddy current test instrument automatically outputting an alternating magnetic field that induces an eddy current in a specimen and sampling the induced eddy current; and
(b) in the response to the eddy current instrument not experiencing acceleration, the eddy current test instrument entering into a low-power state wherein the alternating magnetic field is not output.

2. The method of claim 1, wherein step (a) further includes wireless transmitting data regarding sampled induced eddy currents to a remote computing device.

3. The method of claim 2, wherein data regarding the sampled induced eddy currents are wirelessly transmitted to the remote computing device.

4. The method of claim 1, wherein the eddy current instrument includes an FPGA, an accelerometer, a wireless transmitter or transceiver, a DAC, an ADC, coils, a demodulator, a low pass filter, and/or a portable DC power supply, all housed in a housing.
